(19) United States
(12) Patent Application Publication
(10) Pub. No.: US 2005/0126503 A1
(43) Pub. Date: Jun. 16, 2005

(54) Liquid compositions for feeding birds

(76) Inventor: W. Grady Fort II, Mason, TX (US)

Correspondence Address: PILLSBURY WINTHROP SHAW PITTMAN LLP, 1650 TYSONS BOULEVARD, MCLEAN, VA, 22102, US

(21) Appl. No.: 10/992,136

(22) Filed: Nov. 19, 2004

Related U.S. Application Data
(60) Provisional application No. 60/523,682, filed on Nov. 21, 2003.

(51) Int. Cl. A01K 39/01

(52) U.S. Cl. 119/72

(57) ABSTRACT

A liquid nectar concentrate composition for preparing a liquid bird food or nectar is disclosed. The liquid food concentrate compositions comprises a solution of sucrose, potassium sorbate and optionally FDA Red Dye #40 to provide a convenient means for preparing a safe and palatable nectar that attracts hummingbirds. Also provided is a liquid nectar food composition to provide a convenient, safe and palatable liquid food composition that attracts hummingbirds which contains a solution of sucrose, potassium sorbate and optionally FDA Red Dye #40.

This application claims the benefit of U.S. Provisional Application No. 60/523,682 filed Nov. 21, 2003, which is incorporated herein by reference in its entirety.

### FIELD OF THE INVENTION

The present invention relates generally to animal food. More particularly, the present invention relates to a concentrated liquid food composition used to prepare a liquid nectar food composition for feeding hummingbirds; a container containing the liquid food concentrate composition; and a liquid food composition for feeding hummingbirds that is mold stable.

### BACKGROUND OF THE INVENTION

Hummingbird feeders provide a convenient means to ensure the birds a supply of food in the form of liquid nectar while increasing the owner's chances of observing hummingbirds at relatively close range. A typical feeder is situated near the house or apartment dwelling of the owner. Hummingbird feeders typically dispense a liquid nectar food through a small orifice that provides for gradual and efficient use of the food. The bird feeder owner determines the type of liquid food nectar and feeder used. Solutions for use as a liquid nectar food in a hummingbird feeder typically contain a mixture of sugars and water.

Typical methods for preparing a liquid nectar food for feeding hummingbirds require the owner to mix boiling water with a commercially prepared powder or household sugar. This process is rather tedious to perform on a regular basis, and may result in variations in the composition of the liquid nectar food. Variation in the types and percentages of sugars used can produce a final nectar solution that can cause hummingbirds to infrequently use the feeder. This decreases the feeder's ability to attract birds and decreases the owner's chance of observing the birds at the feeder.

Alternatively, an owner of a hummingbird feeder may prepare liquid food for hummingbirds using any sugar that is available in the owner's house and adding hot or boiling water. Red food coloring is often included in the liquid nectar food solution as a visual attractant for the hummingbirds. Variations in the types and percentages of sugars used may result in a nectar food that is less than attractive to hummingbirds and result in poor use of the feeders.

In both cases, whether using commercial dry powders, or household sugar, the process of preparing the liquid nectar food is necessarily messy, often resulting in sticky spills. Plus, secondary containers are used for the mixing, which adds to the cleanup required after preparation. In addition, the actual amount of liquid nectar food made by starting with powder is often greater than the capacity of a feeder. The excess liquid nectar food produced in this manner must be discarded or refrigerated for limited periods of time. The excess liquid nectar food produced in this manner must be discarded or refrigerated.

A recipe for a home-made syrup solution to feed hummingbirds typically requires boiling a mixture of four parts water and one part table sugar for two minutes over low heat. The boiling dissolves the sugar and kills mold spores and bacteria. Boiling for longer than two minutes changes the concentration of the sugar in the solution. Any unused portion is refrigerated.

Black mold, such as sooty black mold, grows easily on feeder parts. This mold is potentially harmful to hummingbirds; and, as a practical matter, hummingbirds often refuse to use a feeder with black mold growth. Feeders need to be cleaned every few days, and with increased frequency in humid and hot environments. Nectar must be prepared more often, because using a large supply of nectar in such mold friendly environments requires changing the nectar after cleaning the feeder. Use of a nectar syrup made from scratch or from a commercial powder without an effective preservative, requires that the hummingbird feeder be cleaned often, particularly in warm weather. When a hummingbird feeder has been used with a home-made syrup, or nectar dissolved from commercial powder containing ineffective preservative, mold typically appears on the side of the feeder after a few days in ambient conditions. If a nectar solution is produced by dissolving a commercial nectar powder containing sodium benzoate and then placed in a feeder in ambient conditions, then black mold often appears on the side of the feeder in a few days, usually by about the ₈th day post-filling, and most always no later than about the 14th day.

Removal of the visible mold from a hummingbird feeder typically requires time consuming and laborious efforts, such as emptying and rinsing the feeder before trying to loosen the mold using specialized brushes, vinegar, uncooked rice, and vigorous shaking. Thereafter, the feeder must be rinsed several times and allowed to air dry.

Both the homemade and commercial powder preparations are easily contaminated with mold and/or bacteria. Both mold and bacterial contaminants can multiply within the final nectar solution, causing it to spoil in a few days in ambient conditions. The spoiled nectar solution results in minimal use, or non-use of the feeder by hummingbirds and/or actual harm to the birds ingesting the contaminated nectar solution.

In light of the foregoing discussion, there is a need for a liquid nectar food composition that is convenient use in bird feeders and mold stable. Also, there is a need for a liquid nectar concentrate composition for conveniently and easily preparing a liquid nectar food that is mold stable and attracts hummingbirds. There remains a need for a liquid nectar concentrate composition and a liquid nectar food composition that deters mold and/or bacterial build-up within the final liquid nectar food solution.

### BRIEF SUMMARY OF THE INVENTION

The present invention relates to a liquid composition for preparing a food for birds. More particularly, the invention relates to a liquid nectar concentrate composition for preparing a liquid nectar food composition to feed hummingbirds from a bird feeder.

In another embodiment, the composition comprises a solution of cane sugar sucrose and water, in which the sucrose concentration is about 55% to about 70% by weight. In one embodiment of the present invention, the liquid nectar concentrate composition contains from about 55% to about 70% by weight sucrose and from about 0.005% to about 0.10% by weight potassium sorbate.

In a preferred embodiment of the present invention, the liquid nectar concentrate composition contains from about 55% to about 68% by weight sucrose and from about 0.005% to about 0.05% by weight potassium sorbate.

In a more preferred embodiment of the present invention, the liquid nectar concentrate composition of the present invention contains from about 62% to about 63% by weight sucrose and from about 0.02% to about 0.05% by weight potassium sorbate.

In a most preferred embodiment of the present invention, the liquid nectar concentrate composition contains about 62.7% by weight sucrose and about 0.04% by weight potassium sorbate.

In another embodiment of the present invention, the liquid nectar concentrate composition contains from about 55% to about 70% by weight sucrose; from about 0.005% to about 0.10% by weight potassium sorbate; and from about 0.01% to about 0.05% by weight FDA Red Dye #40.

In a preferred embodiment of the present invention, the liquid nectar concentrate composition contains from about 55% to about 68% by weight sucrose; from about 0.005% to about 0.05% by weight potassium sorbate; and from about 0.01% to about 0.035% by weight FDA Red Dye #40.

In a more preferred embodiment of the present invention, the liquid nectar concentrate composition of the present invention contains from about 62% to about 63% by weight sucrose; from about 0.02% to about 0.05% by weight potassium sorbate; and from about 0.01% to about 0.03% by weight FDA Red Dye #40.

In a most preferred embodiment of the present invention, the liquid nectar concentrate composition contains about 62.7% by weight sucrose; about 0.04% by weight potassium sorbate; and about 0.02% by weight FDA Red Dye #40.

Another preferred embodiment of the present invention includes a container that holds the liquid nectar concentrate composition that dispenses the liquid nectar concentrate. The liquid nectar concentrate composition may be dispensed either directly into the bird feeder prior to or after the addition of water or the concentrated may be mixed with water prior to adding it to the feed. In one embodiment of the present invention, the container holding the concentrate is induction sealed to prevent ambient conditions and agents from effecting the liquid nectar concentrate composition prior to its use.

### DESCRIPTION OF THE DRAWINGS

FIG. 1 illustrates nectar consumption by hummingbirds as a function of preservative concentration in the nectar.

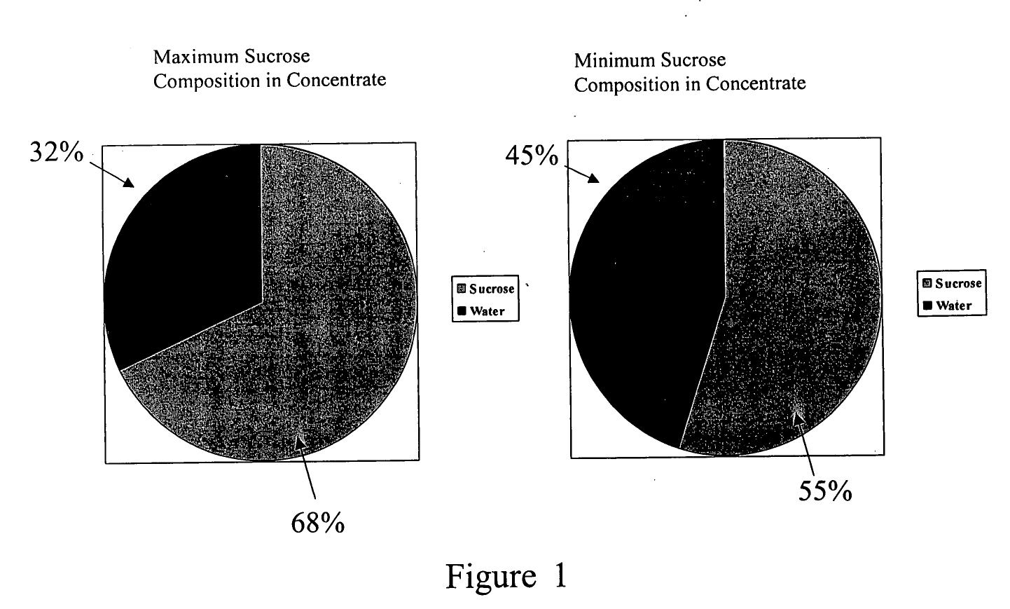

### DETAILED DESCRIPTION OF THE INVENTION

Before one or more embodiments of the invention are described in detail, one skilled in the art will appreciate that the invention is not limited in its application to the details of construction, the arrangements of components, and the arrangement of steps set forth in the following detailed description or illustrated in the drawings. The invention is capable of other embodiments and of being practiced or being carried out in various ways. Also, it is to be understood that the phraseology and terminology used herein is for the purpose of description and should not be regarded as limiting.

Embodiments of the present invention relate to a liquid nectar concentrate composition used for preparing nectars for feeding hummingbirds. In an exemplary embodiment a liquid nectar concentrate composition is disclosed for use in preparing a liquid nectar food composition. The term “liquid nectar concentrate composition” or “nectar concentrate” as used herein refers to a liquid solution to which water is added in order to prepare a liquid nectar food composition for feeding birds. The liquid nectar food composition is the final solution (1× concentration) that is fed directly to the birds. Preferably, the liquid nectar concentrate composition is mixed with water in the hummingbird feeder that will dispense the resulting liquid nectar food composition. Preferably, the feeder container included indicator markings showing incremental proportions of the feeder's volume capacity. The addition of the concentrate composition to the water can be done in any order. In this way, an ideal mix of one part nectar concentrate to three parts water is produced. For example, one quarter of the feeder container's capacity may be filled with the liquid nectar concentrate composition and three quarters of the feeder capacity is filled with water. By mixing the liquid nectar concentrate composition and water within the feeder container, only the exact amount of nectar food composition desired is produced, resulting in no waste or the need to store excess nectar food.

In an exemplary embodiment, a nectar concentrate composition includes a liquid solution of water and sucrose and a preservative, where the sucrose concentration ranges from about 55 weight % to 68 weight %. The liquid nectar concentrate composition comprises a solution of sucrose, a preservative and water. In another embodiment, the nectar concentrate composition includes a liquid solution of water and sucrose and a preservative, in which the sucrose concentration ranges from about 55% by weight to about 70% by weight. Preferably, the sucrose used in the nectar concentrate composition is derived from cane sugar (“cane sugar sucrose”). Hummingbirds have an affinity for sucrose derived from cane sugar. The sucrose is selected from the group consisting of beet sugar sucrose, cane sugar sucrose, and mixtures thereof. Preferably, the sucrose is cane sugar sucrose. Dextrose (glucose) derived from corn is not the preferred sugar for use in preparing the liquid food nectar.

In an exemplary embodiment, a concentrated liquid composition is disclosed for use in preparing a nectar food. In one embodiment, the liquid nectar concentrate composition of the present invention is used to prepare a liquid nectar food composition of the present invention by combining one part liquid nectar concentrate composition and about three parts water. The nectar concentrate composition can be combined with water in the feeder itself or mixed prior to being placed in the bird feeder. In a preferred embodiment of the present invention, the liquid nectar food composition is prepared in a hummingbird feeder dispenser.

The final nectar thus prepared comprises a liquid food composition especially attractive for hummingbirds. Furthermore, since the nectar concentrate composition is a liquid, the present invention provides a more convenient product for accurately preparing the liquid nectar food composition, as compared to the inaccurate concentrations that can result with a powder is added to water.

It a preferred embodiment of the present invention, the liquid nectar concentrate composition comprises about 63% by weight sucrose and water. Preferably, but not limited thereto, the sucrose used in the liquid nectar concentrate is derived from cane sugar. Preferably, the liquid nectar concentrate composition is used to prepare a liquid nectar food composition for hummingbirds by combining one part liquid nectar concentrate and about three parts water. The liquid nectar food composition is fed to birds via a liquid hummingbird feeder or dispenser. The nectar concentrate composition can be combined with the added water in the feeding dispenser itself or in a secondary container before pouring the final preparation of liquid nectar food composition into the feeding dispenser.

The liquid nectar food composition thus prepared comprises a liquid composition of about 19% sugar, which is especially attractive to hummingbirds. Hummingbirds exhibit a preference for nectar having a sugar concentration in the range of about 16-23%. Because it is typically easier to measure portions accurately when they are liquid, rather than a solid, the liquid concentrate composition of the present invention allows the user to easily and reproducibly make a liquid nectar food composition having a sucrose concentration that falls about mid-way within the narrow range preferred by hummingbirds. Preferably, the liquid concentrate composition is diluted to produce a liquid nectar food composition that has a sucrose concentration of about 19%.

Another advantage of the above preferred embodiment is that the probability of sugar crystallization occurring within the nectar concentrate before it is used can be minimized. The liquid nectar concentrate composition of the present invention provides the ability to conveniently and accurately prepare a liquid nectar food composition. If the solid concentration is too high, or if the temperature at which the nectar concentrate is kept is too low, then the liquid nectar concentrate can crystallize, that is, precipitate out sugar solids from solution. For a concentration of 70% sucrose solids in water solution, crystallization can occur at temperatures below about 95° F. However, for a composition of 63% sucrose solids in water, crystallization does not typically occur above about 27° F.

In another exemplary embodiment, the liquid nectar concentrate composition includes about 55% to 68% by weight sucrose and additionally includes about 0.005% to 0.05% by weight preservative. Although the high concentration of sugars in the nectar concentrate can act to retard bacterial growth, harmful or unpalatable mold growth can still take place. Hummingbirds are known to starve in the presence of unpalatable food. See, Elliston, Gillett, 1994, Use of Vital in a Maintenance Diet For Hummingbirds, IWRC Journal, Vol. 17, No. 2.

In a preferred embodiment of the present invention, the nectar concentrate composition includes a low concentration of a preservative, preferably potassium sorbate, so that the composition can be used to prepare a safe and palatable liquid nectar food for hummingbirds. In other embodiments of the present invention, other preservatives may be used alone or in combination with potassium sorbate or with each other, including but not limited to sodium benzoate, citric acid, sorbic acid, and sodium citrate. Sodium benzoate is not used as the sole preservative in the liquid nectar concentrate composition or the liquid nectar food composition of the present invention.

In this manner, the liquid nectar food composition of the present invention requires less maintenance after being dispensed into a feeder, and remains safe to ingest for a longer period of time in feeding hummingbirds.

One commercial powder preparation for producing a liquid nectar food includes the preservative sodium benzoate. Sodium benzoate is not an effective preservative in solutions having a pH above about pH 4.5. Because the liquid nectar food compositions of the present invention have a pH well above pH 4.5, sodium benzoate alone is not an effective preservative. Hummingbird nectars made from commercial powder preparations containing sodium benzoate also have a pH above 4.5. Therefore, they are easily contaminated, not mold stable, and subject to spoilage due to the ineffectiveness of the sodium benzoate preservative. By contrast, potassium sorbate is effective for higher pH foodstuffs and is accordingly much more effective with sucrose based liquid nectar food solutions, whose pH is generally about 6.4.

One aspect of a preferred embodiment of the present invention utilizes the present inventor's discovery that hummingbird consumption of a liquid nectar food composition decreases if the solution contains potassium sorbate concentrations in the original liquid nectar concentrate from which it is made above about 0.050%. Accordingly, although the potassium sorbate preservative is effective in preserving the liquid nectar food composition, preferred embodiments of the present invention that utilize potassium sorbate as the preservative, include potassium sorbate at concentrations below 600 ppm. Accordingly, in another preferred embodiment of the present invention, the nectar concentrate composition includes about 0.005% to about 0.10% potassium sorbate by weight, and most preferably, about 0.04% potassium sorbate. The potassium sorbate preservative is included in the nectar concentrate composition having about 55-70% sucrose. The nectar concentrate composition of the present invention substantially retards spoilage of a liquid nectar food composition while not inhibiting hummingbird consumption.

In a preferred embodiment of the present invention, the liquid nectar concentrate composition is made by adding an amount of dry potassium sorbate powder to a 63% sucrose/water liquid solution so as to result in a 0.04% potassium sorbate liquid solution. In this preferred embodiment of the present invention, the nectar concentrate composition has effective preservative properties while assuring that the preservative remains undetectable or at least does not lower a hummingbird's feeding proclivity for a liquid nectar food produced from the nectar concentrate composition of the present invention.

In other embodiments of the present invention, other preservatives are used alone or in combination with potassium sorbate or with each other, including but not limited to citric acid, sorbic acid, and sodium citrate. Sodium benzoate may not be used as the sole preservative, but may be included with the potassium sorbate, with or without additional preservatives, or combinations thereof. In this manner, the nectar requires less maintenance after being dispensed into a bird feeder, and remains safe for birds to ingest for a longer period of time.

In a further exemplary embodiment, a liquid composition of a nectar concentrate for producing nectar is disclosed containing about 55% to 68% by weight sucrose, additionally including about 0.04 weight % potassium sorbate, and about 0.01% to about 0.05% by weight FDA Red Dye #40.

After a user adds about three parts water to the liquid nectar concentrate solution, the resultant liquid nectar retains a red color which is known to attract hummingbirds.

A still further exemplary embodiment of the present invention comprises a liquid composition of about 55% to 70% by weight sucrose, additionally including about 0.04 weight % potassium sorbate, and about 0.01% to about 0.05% by weight FDA Red Dye #40. A user adds about three parts water to the above liquid nectar concentrate solution; the resultant liquid nectar food retains a red color that is known to attract hummingbirds.

A further exemplary embodiment of the present invention is a package including an induction sealed plastic container including the nectar concentrate. After dispensing the nectar concentrate within the container, the nectar concentrate is sealed by induction heating to produce a seal resistant to opening before intended use. Because of induction sealing during manufacture, the nectar concentrate is further protected from attack by ambient agents such as bacteria or mold during shipping, storage, and prior to use. Preferably, the container includes a screw-top cap, which allows the user to conveniently seal the nectar concentrate container after a first use.

### EXAMPLE 1

From about 0.005% to about 0.10% (by weight percentage of total mix) potassium sorbate is included in the liquid nectar concentrate composition to substantially retard spoilage of both the nectar concentrate composition as well as that of a liquid nectar food composition made from the liquid nectar concentrate composition.

### EXAMPLE 2

Preparation. The nectar concentrate composition of the present invention can be prepared by conventional methods for formulating liquids for human consumption, such as beverages. Such conventional methods can involve hot packing or aseptic packaging operations, pasteurization and the like, although such operations are not necessary for achieving the extended shelf life of the liquid nectar concentrate composition of the present invention at ambient conditions for considerable time. The liquid nectar concentrate composition of the present invention is capable of remaining free of black mold in conditions that correspond to that of a natural hummingbird habitat, for time periods greater than 30 days, including time periods greater than one year, depending on the habitat environment. This extended life occurs even after being exposed to air. Also, in ambient conditions, the liquid nectar food composition of the present invention is capable of remaining free of visible black mold for time periods greater than 14 days, more typically for time periods greater than 30 days. Further, the liquid nectar food composition of the present invention is capable of remaining free of visible black mold, in ambient conditions that include contact with hummingbirds in a natural hummingbird habitat, for time periods greater than 14 days, more typically for time periods greater than 30 days. The length of the time period that the liquid nectar food composition and/or the feeder remains free of visible black mold depends on the environmental conditions in which the feeder is placed. The drier and cooler the hummingbird habitat is, the longer the time period beyond 14 days that the composition and/or feeder remains free of visible black mold. Both the liquid nectar food composition of the present invention and the bird feeder containing the food compositions remain devoid of visible black mold, in ambient conditions for time periods of greater than 14 days, more typically for time periods greater than 30 days.

Thus, both the liquid nectar concentrate composition of the present invention and the liquid nectar food composition of the present invention are capable of inhibiting the growth of black mold, in ambient conditions. The inhibition of black mold growth is typically documented by the visual presence of black spots.

One type of black mold is the sooty mold fungi of the genus Capnodium, which can appear in spots or as a near-continuous coating of the black, tissuepaper-thin sooty mold.

One method for preparing the nectar concentrate composition of the present invention involves making a sucrose concentrate, adding to it to a preservative concentrate, and then trimming the mixture with water to obtain the preferred percentages of the composition. In such a method, the liquid food concentrate can be prepared by admixing to water, sucrose concentrate and preservative. The sucrose concentrate for use in preparing the nectar concentrate composition is separately prepared by adding cane sugar to water. Additional preservative can be added to the resulting sucrose concentrate. It can then be pasteurized, packaged and stored. It is understood that other methods, can be used to prepare the nectar concentrate compositions of the present invention.

The process of producing the nectar concentrate composition of the present invention involves admixing the requisite materials, in the requisite amounts, to achieve the nectar concentrate composition of the present invention. Other well known and conventional variations of the above described formulation technique can, therefore, be used to prepare the nectar concentrate compositions herein.

### EXAMPLE 3

### Test Method: Microbial Stability

The term “mold contamination” as used herein means the visible appearance of mold, typical in the form of black spots in a liquid nectar food composition or the liquid nectar concentrate composition. A nectar concentrate composition is considered mold stable, if the liquid nectar food composition produced from the concentrate is devoid of visible black mold when stored under ambient conditions for at least 15 days, but preferably at least 30 days. A nectar food composition is mold unstable if it exhibits visible black mold when stored in ambient conditions for 14 days or less. A nectar concentrate composition is considered mold stable, if the liquid nectar food composition produced from the concentrate is devoid of visible black mold when stored under ambient conditions for at least 15 days, following an initial contamination of black mold spores. A nectar food composition is mold unstable if it exhibits visible black mold when stored in ambient conditions for 14 days or less, following an initial contamination of black mold spores.

The mold resistance of a liquid nectar concentrate composition or a nectar food composition can be determined by the following method. The liquid composition is inoculated with black mold spores. Inoculated preparations of the liquid nectar food composition are maintained at 20° C. for at least 60 days and aerobic plate cultures performed periodically. Aerobic plate counts of black mold is performed by methods known in the art such as those described in the Compendium of Methods for the Microbiological Examinations of Foods, American Public Health Association, Washington, D.C. (edited by C. Vanderzant and D. F. Splittstoesser), which description is incorporated herein by reference. These plate counts are then used to identify the degree of mold spore growth in the inoculated liquid nectar food composition.

A liquid nectar food composition containing 16% by weight sucrose and 0.005% potassium sorbate and water stored at room temperature is mold stable after 14 days and after 30 days, and even after 45 days. In a most preferred embodiment of the present invention, the liquid nectar concentrate composition remains mold stable for extremely long periods of time, and is capable of remaining mold stable for at least 365 days when stored at room temperature. A nectar preparation containing 16% by weight sucrose and water stored at room temperature is not mold stable, as it exhibits visible black mold after 15 days and most certainly after 45 days and after 365 days.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A liquid nectar concentrate composition comprising:
(a) from about 55% to about 70% by weight of sucrose;
(b) from about 0.005% to about 0.10% by weight of a preservative selected from the group consisting of potassium sorbate, sodium citrate, sorbic acid, citric acid and mixtures thereof; and
(c) added water.

2. The nectar concentrate composition of claim 1, wherein the concentration of the sucrose is from about 55 to about 68% by weight.

3. The nectar concentrate composition of claim 1, wherein the concentration of the sucrose is from about 62 to about 63% by weight.

4. The nectar concentrate composition of claim 1, wherein the concentration of sucrose is about 62.7% by weight sucrose.

5. The nectar concentrate composition of claim 1, wherein the preservative is potassium sorbate.

6. The nectar concentrate composition of claim 5, wherein the concentration of potassium sorbate is from about 0.005% to about 0.10% by weight.

7. The nectar concentrate composition of claim 5, wherein the concentration of potassium sorbate is from about 0.005% to about 0.05% by weight.

8. The nectar concentrate composition of claim 5, wherein the concentration of potassium sorbate is from about 0.02% to about 0.05% by weight.

9. The nectar concentrate composition of claim 5, wherein the concentration of potassium sorbate is from about 0.02% to about 0.03% by weight.

10. The nectar concentrate of claim 5, wherein the concentration of potassium sorbate is about 0.04% by weight.

11. The nectar concentrate composition of claim 1, wherein said composition is mold stable for at least 15 days when stored at room temperature.

12. The nectar concentrate composition of claim 1, further comprising FDA Red Dye #40, wherein the concentration of the FDA Red Dye #40 is from about 0.01% to about 0.05% by weight.

13. The nectar concentrate composition of claim 12, comprising about 62.7% by weight sucrose, about 0.04% by weight potassium sorbate, and about 0.02% by weight FDA Red Dye #40.

14. The nectar concentrate composition of claim 12, wherein the concentration of the FDA Red Dye #40 is from about 0.01% to about 0.035% by weight.

15. The nectar concentrate composition of claim 12, wherein the concentration of the FDA Red Dye #40 is from about 0.01% to about 0.03% by weight.

16. The nectar concentrate composition of claim 12, wherein the concentration of the FDA Red Dye #40 is about 0.02% by weight.

17. The nectar concentrate composition of claim 1, wherein the sucrose is selected from the group consisting of cane sugar sucrose, beet sugar sucrose, and mixtures thereof.

18. The nectar concentrate composition of claims 17, wherein the sucrose is cane sugar sucrose.

19. A nectar concentrate composition consisting essentially of:
(a) from about 55% to about 70% by weight sucrose;
(b) from about 0.0005% to about 0.10% by weight potassium sorbate; and
(c) added water.

20. A nectar concentrate composition consisting essentially of:
(a) from about 55% to about 68% by weight sucrose;
(b) from about 0.005% to about 0.05% by weight potassium sorbate; and
(c) added water.

21. A nectar concentrate composition consisting essentially of:
(a) from about 62% to about 63% by weight sucrose;
(b) from about 0.02% to about 0.05% by weight potassium sorbate; and
(c) added water.

22. A nectar concentrate composition consisting essentially of: about 62.7% by weight sucrose, and about 0.04% by weight potassium sorbate.

23. A nectar concentrate composition consisting essentially of: about 62.7% by weight sucrose, about 0.04% by weight potassium sorbate, and about 0.02% by weight FDA Red Dye #40.

24. A nectar concentrate composition consisting essentially of:
(a) from about 55% to about 70% by weight sucrose;
(b) from about 0.0005% to about 0.10% by weight potassium sorbate;
(c) from about 0.01 to about 0.05% by weight FDA Red Dye #40 and
(d) added water.

25. A nectar concentrate composition consisting essentially of:
(a) from about 55% to about 68% by weight sucrose;
(b) from about 0.005% to about 0.05% by weight potassium sorbate;
(c) from about 0.01 to about 0.035% by weight FDA Red Dye #40 and
(d) added water.

26. A nectar concentrate composition consisting essentially of:
(a) from about 62% to about 63% by weight sucrose;
(b) from about 0.02% to about 0.05% by weight potassium sorbate;
(c) from about 0.01 to about 0.03% by weight FDA Red Dye #40 and
(d) added water.

27. The nectar concentrate composition of claim 19, wherein the sucrose is selected from the group consisting of cane sugar sucrose, beet sugar sucrose, and mixtures thereof.

28. The nectar concentrate composition of claim 27, wherein the sucrose is cane sugar sucrose.

29. A liquid container, comprising a body having a housing containing a liquid nectar concentrate composition, wherein the nectar concentrate composition comprises:
(a) from about 55% to about 70% by weight sucrose;
(b) from about 0.005% to about 0.01% by weight a preservative; and
(c) added water.

30. The liquid container of claim 29, wherein the body has a head part fixed at the tip of the body to provide a liquid supply port at the tip of the body, and a cap detachably attached to the tip portion of the head.

31. The liquid container of claim 29, wherein the body comprises a flexible pouch, wherein said pouch is made of a material selected from the group consisting of foil, plastic and combinations thereof, wherein the pouch includes a flexible wall made of sheet material; and a spout region configured to allow for said concentrate composition to be dispensed therefrom.

32. The liquid container of claim 31, wherein the flexible pouch further comprises a cap for resealing the pouch.

33. The liquid container of claim 29, wherein the preservative is potassium sorbate and wherein the concentration of potassium sorbate is from about 0.005% to about 0.10% by weight.

34. The liquid container of claim 33, wherein the concentration of potassium sorbate is from about 0.005% to about 0.05% by weight.

35. The liquid container of claim 33, wherein the concentration of potassium sorbate is from about 0.02% to about 0.05% by weight.

36. The liquid container of claim 33, wherein the concentration of potassium sorbate is about 0.04% by weight.

37. The liquid container of claim 33, wherein said composition is mold stable for at least 15 days when stored at room temperature.

38. The liquid container of claim 29, wherein the nectar concentrate composition further comprises FDA Red Dye #40 in a concentration from about 0.01% to about 0.03% by weight.

39. The liquid container of claim 29, wherein the preservative is selected from the group consisting of: potassium sorbate; sodium citrate; sorbic acid; and citric acid.

40. The liquid container of claim 29, wherein the sucrose is selected from the group consisting of cane sugar sucrose, beet sugar sucrose, and mixtures thereof.

41. The liquid container of claim 29, wherein the sucrose is cane sugar sucrose.

42. A liquid container, comprising a body having a housing containing a liquid nectar concentrate composition, wherein the body has a head part fixed at the tip of the body to provide a liquid supply port at the tip of the body, and a cap detachably attached to the tip portion of the head, wherein the nectar concentrate composition consists essentially of:
(a) from about 55% to about 70% by weight sucrose;
(b) from about 0.005% to about 0.10% by weight a preservative; and
(c) added water.

43. A liquid container, comprising a body having a housing containing a liquid nectar concentrate composition, wherein the body has a head part fixed at the tip of the body to provide a liquid supply port at the tip of the body, and a cap detachably attached to the tip portion of the head, wherein the nectar concentrate composition consists essentially of:
(a) from about 55% to about 70% by weight sucrose;
(b) from about 0.005% to about 0.10% by weight a preservative;
(c) about 0.01% to about 0.05% by weight FDA Red Dye #40; and
(d) added water.

44. A liquid container, comprising a body having a housing containing a liquid nectar concentrate composition, wherein the body has a head part fixed at the tip of the body to provide a liquid supply port at the tip of the body, and a cap detachably attached to the tip portion of the head, wherein the nectar concentrate composition comprises:
(a) about 62.7% by weight sucrose;
(b) about 0.04% potassium sorbate;
(c) about 0.02% by weight FDA Red Dye #40; and
(d) added water.

45. A liquid container, comprising a body having a housing containing a liquid nectar concentrate composition, wherein the body has a head part fixed at the tip of the body to provide a liquid supply port at the tip of the body, and a cap detachably attached to the tip portion of the head, wherein the nectar concentrate composition consists essentially of:
(a) about 62.7% by weight sucrose;
(b) about 0.04% potassium sorbate;
(c) about 0.02% by weight FDA Red Dye #40; and
(d) added water.

46. The liquid container of claim 29, wherein the liquid supply port is induction sealed.

47. The liquid container of claim 29, wherein the sucrose is cane sugar sucrose.

48. A liquid nectar food composition comprising:
(a) from about 13% to about 25% by weight of sucrose;
(b) from about 0.00125% to about 0.025% by weight of a preservative selected from the group consisting of potassium sorbate, sodium citrate, sorbic acid, citric acid and mixtures thereof; and
(c) added water.

49. The food composition of claim 48, wherein the concentration of sucrose is from about 13.75% to about 17% by weight.

50. The food composition of claim 48, wherein the concentration of sucrose is from about 17% to about 20% by weight.

51. The food composition of claim 48, wherein the concentration of sucrose is about 19% by weight sucrose.

52. The food composition of claim 48, wherein the preservative is potassium sorbate.

53. The food composition of claim 52, wherein the concentration of potassium sorbate is from about 0.00125% to about 0.025% by weight.

54. The nectar food composition of claim 52, wherein the concentration of potassium sorbate is from about 0.005% to about 0.03% by weight.

55. The nectar food composition of claim 52, wherein the concentration of potassium sorbate is from about 0.01% to about 0.03% by weight.

56. The nectar food of claim 52, wherein the concentration of potassium sorbate is about 0.013% by weight.

57. The nectar food composition of claim 48, wherein when said composition is placed in a mold-free bird feeder under ambient conditions, no visible black mold appears in or on said feeder for at least 15 days.

58. The nectar food composition of claim 48, wherein said composition is mold stable for at least 30 days when stored at room temperature.

59. The nectar food composition of claim 48, further comprising from about 0.005% to about 0.007% by weight FDA Red Dye #40.

60. The nectar food composition of claim 59, comprising about 19% sucrose, about 0.013% potassium sorbate, and about 0.006% FDA Red Dye #40.

61. A nectar food composition consisting essentially of:
(a) from about 13% to about 25% by weight sucrose;
(b) from about 0.0125% to about 0.025% by weight potassium sorbate; and
(c) added water.

62. A nectar food composition consisting essentially of
(a) from about 13.75% to about 17% by weight sucrose;
(b) from about 0.005% to about 0.03% by weight potassium sorbate; and
(c) added water.

63. A nectar food composition consisting essentially of
(a) from about 17% to about 20% by weight sucrose;
(b) from about 0.01% to about 0.03% by weight potassium sorbate; and
(c) added water.

64. A nectar food composition consisting essentially of:
(a) about 19% by weight sucrose;
(b) about 0.013% potassium sorbate; and
(c) added water.

65. A nectar food composition consisting essentially of:
(a) from about 13% to about 25% by weight sucrose;
(b) from about 0.00125% to about 0.025% by weight potassium sorbate;
(c) from about 0.005% to about 0.007% by weight FDA Red Dye #40; and
(d) added water.

66. A nectar food composition consisting essentially of:
(a) from about 13.75% to about 17% by weight sucrose;
(b) from about 0.005% to about 0.03% by weight potassium sorbate;
(c) from about 0.005% to about 0.007% by weight FDA Red Dye #40; and
(d) added water.

67. A nectar food composition consisting essentially of:
(a) from about 17% to about 20% by weight sucrose;
(b) from about 0.01% to about 0.03% by weight potassium sorbate;
(c) from about 0.005% to about 0.007% by weight FDA Red Dye #40; and
(d) added water.

68. A nectar food composition consisting essentially of:
(a) about 19% by weight sucrose;
(b) about 0.013% by weight potassium sorbate;
(c) about 0.006% by weight FDA Red Dye #40; and
(d) added water.

69. The nectar concentrate composition of claim 48, wherein the sucrose is selected from the group consisting of cane sugar sucrose, beet sugar sucrose, and mixtures thereof.

70. The nectar concentrate composition of claim 61, wherein the sucrose is cane sugar sucrose.

71. A liquid container, comprising a body having a housing containing a liquid nectar food composition, wherein the food composition comprises:
(a) from about 13% to about 25% by weight of sucrose;
(b) from about 0.00125% to about 0.025% by weight of a preservative selected from the group consisting of potassium sorbate, sodium citrate, sorbic acid, citric acid and mixtures thereof; and
(c) added water.

72. The liquid container of claim 71, wherein the body has a head part fixed at the tip of the body to provide a liquid supply port at the tip of the body, and a cap detachably attached to the tip portion of the head.

73. The liquid container of claim 71, wherein the body comprises a flexible pouch, wherein said pouch is made of a material selected from the group consisting of plastic, foil, and mixtures thereof.

74. The liquid container of claim 71, wherein the preservative is potassium sorbate and said potassium sorbate is present in a concentration from about 0.005% to about 0.007% by weight.

75. The liquid container of claim 74, wherein the potassium sorbate concentration is about 0.006% by weight.

76. The liquid container of claim 71, wherein the nectar food composition further comprises FDA Red Dye #40.

77. The liquid container of claim 71, wherein the preservative is selected from the group consisting of: potassium sorbate; sodium citrate; sorbic acid; citric acid and mixtures thereof.

78. A liquid container, comprising a body having a housing containing a liquid nectar food composition, wherein the body has a head part fixed at the tip of the body to provide a liquid supply port at the tip of the body, and a cap detachably attached to the tip portion of the head, wherein the nectar food composition comprises:
(a) from about 13% to about 25% by weight of sucrose;
(b) from about 0.00125% to about 0.025% by weight of a preservative selected from the group consisting of potassium sorbate, sodium citrate, sorbic acid, citric acid and mixtures thereof; and
(c) added water.

79. The liquid container of claim 72, wherein the liquid supply port is induction sealed.

80. The liquid container of claim 71, wherein the sucrose is cane sugar sucrose.

81. The liquid container of claim 71, wherein the food composition is pasteurized.
